(19) United States
(12) Patent Application Publication
(10) Pub. No.: US 2018/0226784 A1
(43) Pub. Date: Aug. 9, 2018

(54) Adaptable Heat Shrink Tubing

(71) Applicant: John Matthew Shull, Campbell, CA (US)

(72) Inventor: John Matthew Shull, Campbell, CA (US)

(21) Appl. No.: 15/871,989

(22) Filed: Jan. 16, 2018

Related U.S. Application Data
(60) Provisional application No. 62/454,809, filed on Feb. 5, 2017.

(51) Int. Cl. H02G 15/18; H01B 17/58; C09J 7/35; C09J 7/22; H01B 7/17

(52) U.S. Cl. CPC H02G 15/1813; H01B 17/58; H01B 7/17; C09J 7/22; C09J 7/35

(57) ABSTRACT

Adaptable heat shrink tubing is able to be applied over existing in service wires or where tubing would not normally be able to be passed over the end of a connector.

### CROSS-REFERENCE TO RELATED APPLICATIONS

This nonprovisional application claims priority to provisional application No. 62/454,809, entitled “ADAPTABLE HEAT SHRINK TUBING,” filed, Feb. 5, 2017 by the same inventor.

### STATEMENT REGARDING FEDERALLY SPONSORED RESEARCH OR DEVELOPMENT

Not Applicable

### NAMES OF THE PARTIES TO A JOINT RESEARCH AGREEMENT IF THE CLAIMED INVENTION WAS MADE AS A RESULT OF ACTIVITIES WITHIN A SCOPE OF A JOINT RESEARCH PROGRAM

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

### Field of the Invention

This invention relates, generally to the application of heat shrink tubing. More specifically, relating to the ability to apply heat shrink tubing to existing circuits, existing wiring, or over existing electrical connections with exposed wiring or exposed conductive parts without having to remove or desolder the wires in order to apply the heat shrink tubing.

### Brief Description of the Prior Art

Heat shrink tubing sold on the market today is a one piece cylindrical “sleeve” of various colors made of PVC, Polyolefin, or Teflon of various diameters, lengths, wall thickness, stiffness, and colors which requires the user to slide the wire through the heat shrink tubing before soldering or crimping their wire to their connector or circuit.

Existing heat shrink tubing doesn't allow for the application of the heat shrink tubing over a circuit that is in service. Applying tubing to this type of circuit would require the user to shut down power and disconnect the wire from the circuit or desolder the wire.

Additionally, larger diameter heat shrink tubing that does pass over the end of a spade connector and then slide to the position of the exposed wiring would need to be properly researched by the user in order to understand what shrink ratio tubing would be most effective. A shrink ratio too small will not insulate the wire and require the user to have to cut the tubing off the wire and experiment until they find the proper tubing with the proper shrink ratio. For example, a user would need to understand the diameters of their wires along with choosing the correct shrink tubing ratio. A 2:1 shrink ratio where a tube will shrink to half its original diameter or a 3:1 ratio will shrink to ⅙ of an inch. This may lead to experimenting, wasted time and frustration to find the correct shrink ratio tubing.

### BRIEF SUMMARY OF THE INVENTION

The invention of adaptable heat shrink tubing is made up of a split open lengthwise piece of insulating heat shrink tubing made of polyolefin, PVC, rubber or Teflon material with heat activated adhesive on the inside lengths of the tubing in various widths depending on the diameter of the tubing.

The user does not need to disconnect or unsolder their existing electrical connection, and instead places the appropriate diameter sized adaptable heat shrink tubing over the exposed circuit, applies heat, which then shrinks the tubing around the electrical wire and activates the adhesive in the tubing which bonds to the wire insulation of the circuit and also to the heat shrink tubing forming a sealed and protective insulation.

### BRIEF DESCRIPTION OF THE DRAWINGS

For an understanding of the invention, reference should be made to the following detailed description, taken in connection with the drawings in which:

FIG. 1 is an outside view of the adaptable heat shrink tubing which would be available in various diameters and colors. The tubing is curled and overlaps the other end of the tubing, but separate as displayed in (1). The lengthwise separation allows for easy application around a wire.

FIG. 2 is the inside laid down view of the adaptable heat shrink tubing in a spread opened position where the heat activated adhesive strips labeled as (2) runs lengthwise on the upper and lower ends of the tubing in various widths depending on the diameter of the tubing.

### DESCRIPTION OF THE PREFERRED EMBODIMENT

This invention is an improvement upon existing heat shrink tubing which is only found in hollow cylindrical one piece forms of various colors.

The invention of adaptable heat shrink tubing expands upon the curling of the tubing to allow it to curl over the wire to be insulated and itself, but is split open lengthwise so there is no need to slide it as a sleeve over the end of the wiring.

Heat activated adhesive strips run lengthwise inside the tubing on the inner extremities of the tubing are of various widths depending on the diameter of the tubing. The heat activated adhesive would be formulated to be activated and cured at the appropriate temperature and activation time depending on the material of the shrink tubing. The recommended shrink temperature of heat shrink tubing is around 90° C. with other materials as high as 250° C. such as Teflon and is achieved with a heat gun.

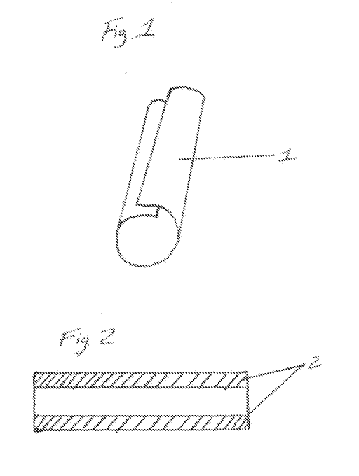

The adaptable heat shrink tubing would be wrapped around the wire, while the other end would overlap over the other end of the heat shrink as viewed in FIG. 1. Once heat is applied, the adhesive would activate causing adherence to the wire and also adherence to the outer shrink tubing while also shrinking the tubing material over the wire.

The embodiment may have positional or width variations of the heat activated adhesive strips which does not depart from the scope or intention of the invention.

1. Adaptable Heat Shrink Tubing: consisting of a hollow flexible split tubing made of various wall thickness compromised of materials such as Polyolefin, Irradiated PVC, Irradiated Kynar, Teflon FEP, Teflon TFE, Irradiated elastomer, Irradiated Viton, or Irradiated silicon rubber with heat activated adhesive on the inside walls.
Heat activated adhesive: strips of various widths and positions which line the inside of the adaptable heat shrink tubing formulated to cure and adhere at specific temperatures depending on the material of the shrink tubing used.
Curl: The tubing is curled which will allow overlapping and adhesion of one layer of the tubing onto the other surface of the tubing and to the wiring being applied to; therefore, not exposing any insulation of the wire that is having the adaptable heat shrink tubing applied to.
